(19) United States
(12) Patent Application Publication
(10) Pub. No.: US 2020/0208806 A1
(43) Pub. Date: Jul. 2, 2020

(54) LIGHTING ELEMENT AND LIGHTING PROVIDED WITH THE LIGHTING ELEMENT

(71) Applicant: BLG Group B.V., Son en Breugel (NL)

(72) Inventor: Johannes Antonius Wouter BELGERS, Son en Breugel (NL)

(21) Appl. No.: 16/608,834

(22) PCT Filed: Apr. 20, 2018
(86) PCT No.: PCT/NL2018/050255

§ 371 Date: Oct. 27, 2019

(30) Foreign Application Priority Data
Apr. 26, 2017 (NL) 2018788

(51) Int. Cl. F21V 9/08; F21S 4/20

(52) U.S. Cl. CPC F21V 9/08; G09F 13/00; F21S 4/20

(57) ABSTRACT

A lighting consists of a plate 3 to be illuminated and an elongated lighting element 1. The plate is provided with a first surface 5 in a first color and a second surface 7 in a second color. The lighting element 1 has an elongated housing 9 with a translucent wall, as well as a number of light sources 11 in the housing and distributed over the length of the housing. The lighting element 1 extends along the dividing line 13 between the two surfaces 5 and 7. The elongated housing 9 is provided with a first transparent wall part 15 facing the first surface 5 and a second transparent wall part 17 which at least partially faces the second surface 7. The first wall part 15 has the same or substantially the same color as the first surface 5 and the second wall part 17 has the same or substantially the same color as the second surface 7.

### TECHNICAL FILED OF THE INVENTION

The invention relates to a lighting element for illuminating an object, comprising an elongate housing with a translucent wall, and a number of light sources being in the housing and distributed over the length of the housing. The lighting serves to allow different parts of the object to be clearly visible in the dark. This is particularly important in case the article is formed or part of a billboard or recognition symbol of a company.

### BACKGROUND OF THE INVENTION

Such a lighting element is generally known. The known lighting element has a housing of a color and can be attached to an object to be illuminated via brackets. In case many objects have to be illuminated, it is important that the costs of the lighting element are preferably low.

### SUMMARY OF THE INVENTION

An object of the invention is to provide a lighting element of the type described in the preamble in which an object can be better illuminated at equal or lower cost than with the known lighting element. To this end the lighting element according to the invention is characterized in that the elongated housing is provided with a first transparent wall part with a color for illuminating a first part of the object with that color and a second transparent wall part) with a different color illuminating a second part of the object with that other color. By illuminating different parts of the object in different colors, the visibility of the object can be optimized. With the lighting element according to the invention a better illumination of an object with different colored parts can be realized than with the known lighting element which illuminates all parts of the object with the same color. By using uniform light sources and making the wall of the housing in different colors in an inexpensive way, the lighting element according to the invention can moreover be manufactured more cheaply than the known lighting element. Preferably, the housing is extruded from two plastics with different colors.

In case the first wall part is yellow and the other wall part is red, the light-transmitting surface of the housing is preferably formed for 20-40% by the first wall part and for the remaining part by the second wall part to obtain a comparable visibility of the parts to be illuminated.

The invention also relates to a lighting comprising an object to be illuminated, preferably a plate, which is provided with a first surface in a first color and a second surface in a second color, and a lighting element according to the invention. With regard to the lighting, the invention is characterized in that the lighting element extends along the dividing line between the two surfaces and the first transparent wall part faces the first surface and the second transparent wall part is at least partly directed towards the second surface. With “the dividing line” also an arrangement has to be understood in which the lighting element is at a short distance from the dividing line on or above one of the surfaces and extends in the direction of the dividing line.

Preferably the first wall part has the same or substantially the same color as the first surface and the second wall part has the same or substantially the same color as the second surface. As a result, better illumination of the surfaces is obtained.

### BRIEF DESCRIPTION OF THE DRAWINGS

The invention will be further elucidated below on the basis of drawings. These drawings show an embodiment of lighting according to the present invention. In the drawings:

FIG. 1 shows an embodiment of the lighting in cross-section; and

FIG. 2 shows the lighting in top view.

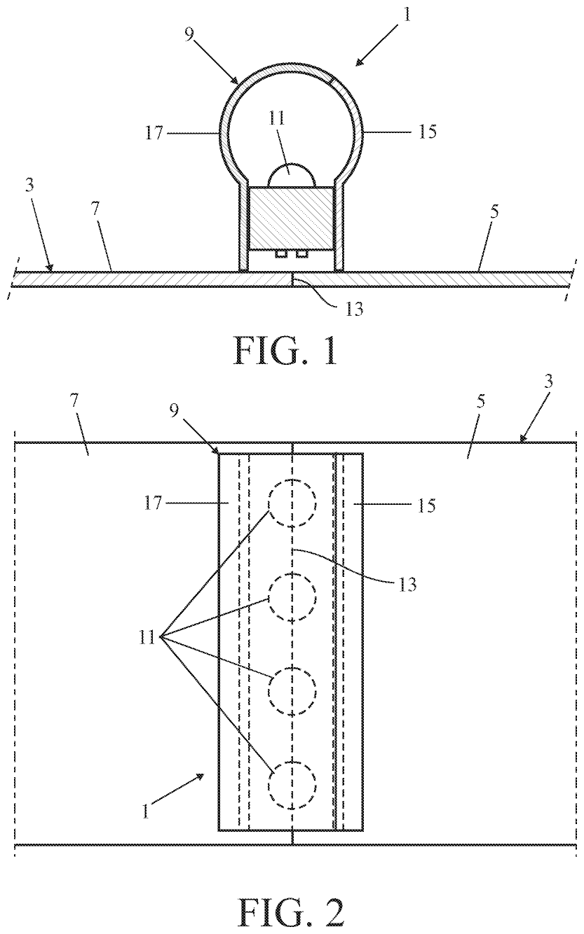

### DETAILED DESCRIPTION OF THE DRAWINGS

A lighting consists of a plate 3 to be illuminated and an elongated lighting element 1. The plate is provided with a first surface 5 in a first color and a second surface 7 in a second color. The lighting element 1 has an elongated housing 9 with a translucent wall, as well as a number of light sources 11 in the housing and distributed over the length of the housing. The lighting element 1 extends along the dividing line 13 between the two surfaces 5 and 7.

The elongated housing 9 is provided with a first transparent wall part 15 facing the first surface 5 and a second transparent wall part 17 which at least partially faces the second surface 7. The first wall part 15 has the same or substantially the same color as the first surface 5 and the second wall part 17 has the same or substantially the same color as the second surface 7, the first wall part 15 having a color different from the second wall part 17.

During use the light-transmitting area of the housing 9 is approximately 35% formed by the first wall part 15 and the remaining 65% is formed by the second wall part 17. This ratio is particularly optimal in case the first surface 5 is red and the second surface is yellow to obtain a similar visibility of the yellow and red surface.

Although the present invention is elucidated above on the basis of the given drawings, it should be noted that this invention is not limited whatsoever to the embodiments shown in the drawings. The invention also extends to all embodiments deviating from the embodiments shown in the drawings within the context defined by the claims.

1. A lighting element for illuminating an object, comprising an elongate housing with a translucent wall, and a number of light sources being in the housing and distributed over the length of the housing, characterized in that the elongated housing is provided with a first transparent wall part with a color for illuminating a first part of the object with that color and a second transparent wall part with a different color illuminating a second part of the object with that other color.

2. The lighting element according to claim 1, characterized in that the light-transmitting surface of the housing during operation is 20-40% formed by the first wall part and the remaining part is formed by the second wall part.

3. The lighting element according to claim 1, characterized in that one of the wall parts is red and the other wall part is yellow.

4. A lighting comprising an object to be illuminated, preferably a plate, which is provided with a first surface with a first color and a second surface with a second color, and a lighting element according to claim 1, characterized in that the lighting element extends along the dividing line between the two surfaces and the first transparent wall part faces the first surface and the second transparent wall part is at least partially facing the second surface.

5. The lighting according to claim 4, characterized in that the first wall part has the same or substantially the same color as the first surface and the second wall part has the same or substantially the same color as the second surface.
